(19) United States
(12) Patent Application Publication
(10) Pub. No.: US 2025/0216500 A1
(43) Pub. Date: Jul. 3, 2025

(54) BACKSCATTER AMBIENT POWER (AMP) DEVICE DETECTION AND CHARACTERIZATION USING ULTRA WIDEBAND (UWB) IMPULSE RADAR

(71) Applicant: Cisco Technology, Inc., San Jose, CA (US)

(72) Inventor: Sivadeep Reddy Kalavakuru, Akron, OH (US)

(73) Assignee: Cisco Technology, Inc., San Jose, CA (US)

(21) Appl. No.: 19/005,618

(22) Filed: Dec. 30, 2024

Related U.S. Application Data
(60) Provisional application No. 63/615,878, filed on Dec. 29, 2023.

(51) Int. Cl. G01S 5/14; G06K 7/10; H04L 25/02

(52) U.S. Cl. CPC G01S 5/14; G06K 7/10158; G06K 7/10306; H04L 25/0212

(57) ABSTRACT

Backscatter AMP device detection and characterization using Ultra Wideband (UWB) impulse radar may be provided. First, a computing device may transmit an UWB signal comprising pulses to a Backscatter Device (BKD). Next, the computing device may receive a reflection of the UWB signal from the BKD in response to the UWB signal. Then the computing device may locate the BKD using a Channel Impulse Response (CIR) of the reflection of the UWB signal.

### RELATED APPLICATION

Under provisions of 35 U.S.C. § 119 (e), Applicant claims the benefit of U.S. Provisional Application No. 63/615,878, filed Dec. 29, 2023, which is incorporated herein by reference.

### TECHNICAL FIELD

The present disclosure relates generally to providing backscatter Ambient Power (AMP) device detection and characterization using Ultra Wideband (UWB) impulse radar.

BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing backscatter Ambient Power (AMP) device detection and characterization using Ultra Wideband (UWB) impulse radar;

FIG. 2 is a flow chart of a first method for providing backscatter AMP device detection and characterization using UWB impulse radar;

FIG. 3 is a block diagram of an operating environment for providing backscatter AMP device detection and characterization using UWB impulse radar;

FIG. 4 is a flow chart of a first method for providing backscatter AMP device detection and characterization using UWB impulse radar; and

FIG. 5 is a block diagram of a computing device.

### DETAILED DESCRIPTION

### Overview

Backscatter AMP device detection and characterization using Ultra Wideband (UWB) impulse radar may be provided. First, a computing device may transmit an UWB signal comprising pulses to a Backscatter Device (BKD). Next, the computing device may receive a reflection of the UWB signal from the BKD in response to the UWB signal. Then the computing device may locate the BKD using a Channel Impulse Response (CIR) of the reflection of the UWB signal.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Ambient Power (AMP) Backscatter Devices (BKDs) may use ambient energy, for example, Radio Frequency (RF) signals to transmit data without a power source such as a battery or a connection to electricity. BKDs may use an antenna to receive the RF signals, use the RF signals for excitation (e.g., convert the RF signal into electricity), and use the power to modify and reflect the RF signals with data. Other devices may receive reflected RF signals transmitted by a BKD to process the data the BKD is sending.

There may be two types of BKDs: i) passive BKDs (pBKDs) and ii) active BKDs (aBKDs). A pBKD may directly reflect back the energy it receives. An aBKD may include a capacitor and may thus charge until it sends its own frame. As discussed above, BKDs may be powered by ambient energy (for example, RF signals such as Wi-Fi signals or cellular signals) present in the surrounding environment.

In order to decrease the power requirements of BKDs (e.g., AMP Internet-of-Things (IOT) devices), backscattering may be leveraged. In backscattering, an AP may transmit a source signal and the BKD may use on/off keying by changing its reflective property to make 1s and 0s that may show up at a receiver (e.g., the AP).

With the rapid growth of BKDs, there may be a need to detect such devices in a network and characterize them based on their backscattering RF signature. UWB impulse radar radios may be implemented in upcoming APs for axillary features. These UWB radios may emit electromagnetic pulses and listen for their echoes to provide ranging estimates. They may have high spatial range resolution. Echo signatures from BKDs may be distinguished and used to create a range of profiles of the environment, providing information about location and signature of the BKDs. Embodiments of the disclosure may provide processes to characterize and detect BKDs leveraging UWB impulse radar.

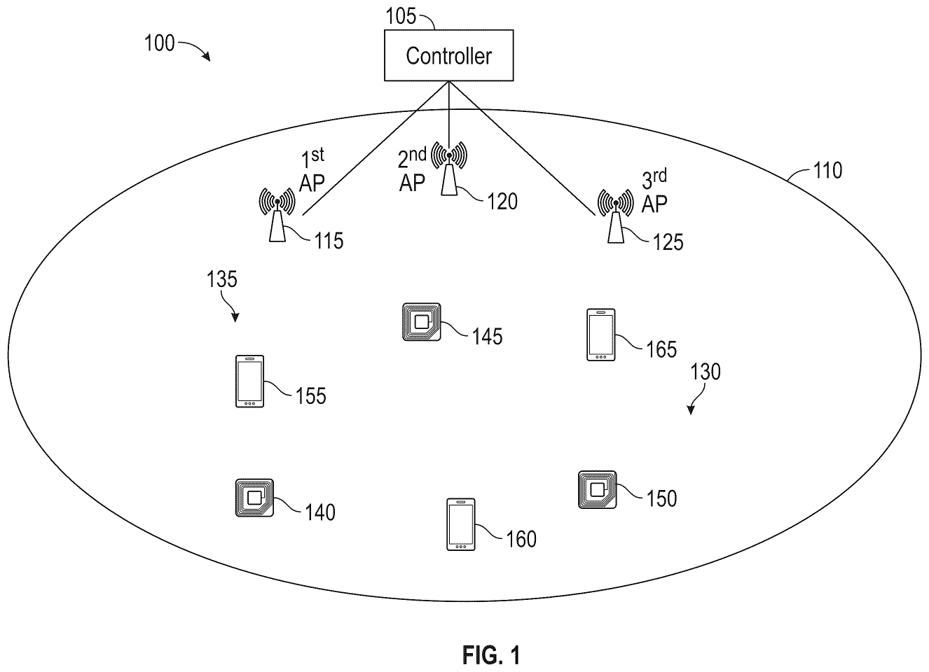

FIG. 1 shows an operating environment 100 for providing backscatter AMP device detection and characterization using UWB impulse radar. As shown in FIG. 1, operating environment 100 may comprise a controller 105 and a coverage environment 110. Coverage environment 110 may comprise, but is not limited to, a Wireless Local Area Network (WLAN) comprising a plurality of Access Points (APs) that may provide wireless network access (e.g., access to the WLAN) for devices. The plurality of APs may comprise a first AP 115, a second AP 120, and a third AP 125. Each of the plurality of APs may be compatible with specification standards such as, but not limited to, the Institute of Electrical and Electronics Engineers (IEEE) 802.11 specification standard for example.

A first plurality of devices 130 and a second plurality of devices 135 (i.e., STAs) may be deployed in coverage environment 110. The plurality of APs may provide wireless network access to first plurality of devices 130 and second plurality of devices 135 as the devices move within coverage environment 110. Coverage environment 110 may comprise an outdoor or indoor wireless environment for Wi-Fi or any type of wireless protocol or standard.

First plurality of devices 130 may comprise a first device 140, a second device 145, and a third device 150. First plurality of devices 130 may comprise BKDs, for example, Radio Frequency Identifier (RFID) tags. First plurality of devices 130 may comprise, but are not limited to, general energy harvesting devices (e.g., passive backscatter communication devices) and pure backscatter communication devices. General energy harvesting devices may comprise devices that work in two phases: i) first harvesting RF energy for a time period; then ii) transmitting using this harvested RF energy. General energy harvesting devices may comprise battery-less Bluetooth Low Energy (BLE) chips for example. With a pure backscatter communication device, the RF signal that provides power may also be the one that is backscattered/modified according to some modulation hence encoding some symbols of information. In addition, first plurality of devices 130 may comprise devices that may receive or harvest energy from light energy and then use the energy from light to power transmission. First plurality of devices 130 may also comprise devices that may harvest RF energy to recharge a battery or other energy storage element (e.g., a capacitor) within the device.

Second plurality of devices 135 may comprise a first client device 155, a second client device 160, and a third client device 165. Ones of second plurality of devices 135 may comprise, but are not limited to, a smart phone, a personal computer, a tablet device, a mobile device, a telephone, a remote control device, a set-top box, a digital video recorder, an Internet-of-Things (IoT) device, a network computer, a router, an AR/VR device an Automated Transfer Vehicle (ATV), a drone, an Unmanned Aerial Vehicle (UAV), a smart wireless light bulb, or other similar microcomputer-based device.

The plurality of APs and second plurality of devices 135 may use Multi Link Operation (MLO) where they simultaneously transmit and receive across different bands and channels by establishing two or more links to two or more AP radios. These bands may comprise, but are not limited the 2 GHz band, the 5 GHz band, the 6 GHz band, and the 60 GHz band. The two or more links on any given one of the plurality of client devices may be made with any one AP or with any combination of the APs.

The plurality of APs and second plurality of devices 135 may also have Ultra Wideband UWB radios that may use UWB radio technology using a very low energy level for short-range, high-bandwidth communications over a large portion of the radio spectrum. UWB may transmit information across a wide bandwidth (e.g., >500 MHz). This may allow for the transmission of a large amount of signal energy without interfering with conventional narrowband and carrier wave transmission in the same frequency band. Regulatory limits in many countries may allow for this efficient use of radio bandwidth, and enable high-data-rate personal area network (PAN) wireless connectivity, longer-range low-data-rate applications, and the transparent co-existence of radar and imaging systems with existing communications systems.

Controller 105 may comprise a Wireless Local Area Network controller (WLC) and may provision and control coverage environment 110 (e.g., a WLAN). Controller 105 may allow the plurality of client devices to join coverage environment 110. In some embodiments of the disclosure, controller 105 may be implemented by a Digital Network Architecture Center (DNAC) controller (i.e., a Software-Defined Network (SDN) controller) that may configure information for coverage environment 110 in order to provide backscatter AMP device detection and characterization using UWB impulse radar.

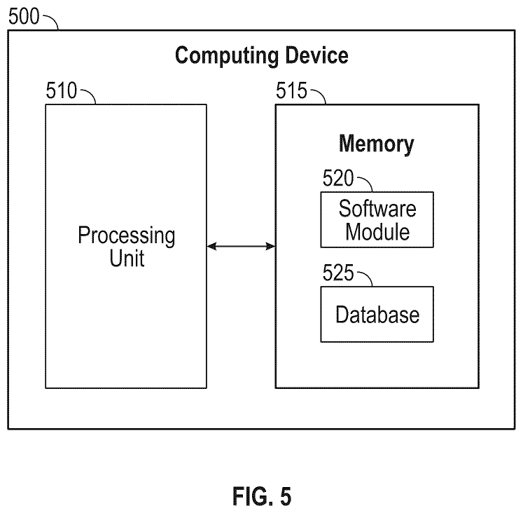

The elements described above of operating environment 100 (e.g., controller 105, first AP 115, second AP 120, third AP 125, first device 140, second device 145, third device 150, first client device 155, second client device 160, and third client device 165) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 5, the elements of operating environment 100 may be practiced in a computing device 500.

### Backscattering AMP Device Localization

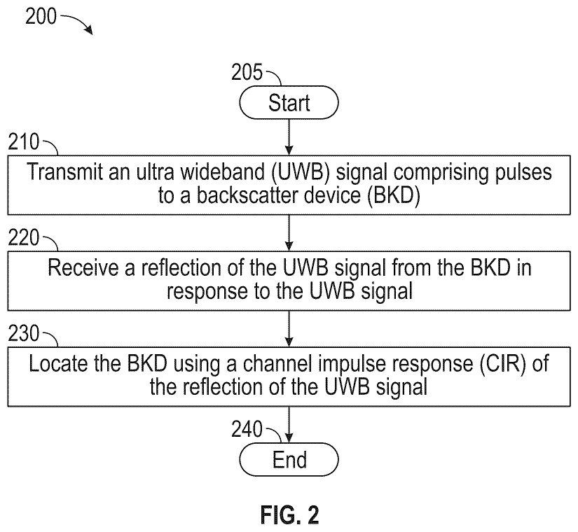

FIG. 2 is a flow chart setting forth the general stages involved in a method 200 consistent with embodiments of the disclosure for providing backscatter AMP device detection and characterization using UWB impulse radar. Method 200 may be implemented, for example, using computing device 500 that may be embodied by first AP 115 as described in more detail above with respect to FIG. 1. Ways to implement the stages of method 200 will be described in greater detail below.

Method 200 may begin at starting block 205 and proceed to stage 210 where first AP 115 may transmit a UWB signal comprising pulses to a BKD (e.g. first device 140). For example, UWB radar may have a high repetition of electromagnetic impulses and may listen to its echo waves to characterize and locate objects in its vicinity.

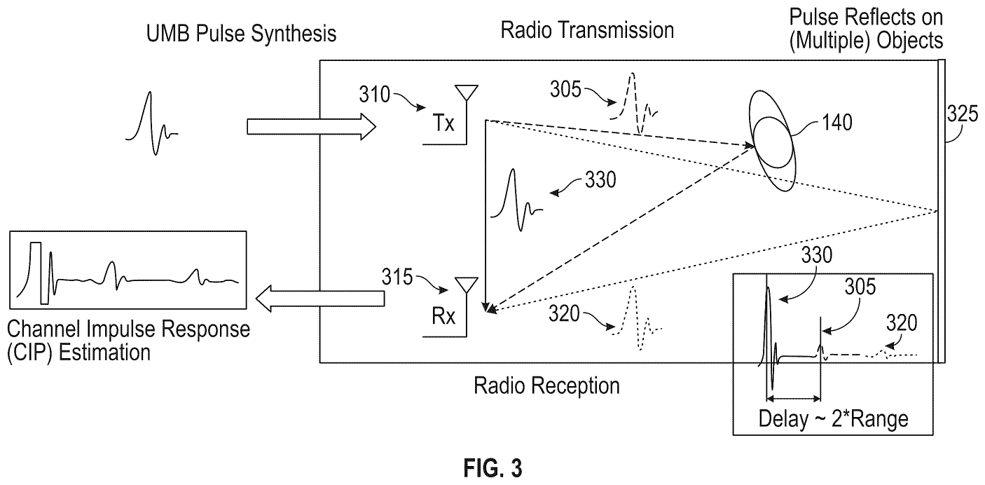

From stage 210, where first AP 115 transmits the UWB signal comprising pulses to the BKD, method 200 may advance to stage 220 where first AP 115 may receive a reflection of the UWB signal from the BKD in response to the UWB signal. For example, as shown in FIG. 3, first AP 115 may synthesize UWB pulses and transmit them as a first signal 305 from its Transmit (Tx) antenna 310. First signal 305 may reflect off first device 140 (e.g., the BKD) and the reflection of first signal 305 off first device 140 may be received by a Receive (Rx) antenna 315 of first AP 115. Pulses may be transmitted as a second signal 320 from Tx antenna 310, reflected off a wall 325, and received by Rx antenna 315. Furthermore, pulses may be transmitted as a third signal 330 from Tx antenna 310 and received directly by Rx antenna 315.

Once first AP 115 receives the reflection of the UWB signal from the BKD in response to the UWB signal in stage 220, method 200 may continue to stage 230 where first AP 115 may locate the BKD using a Channel Impulse Response (CIR) of the reflection of the UWB signal. For example, BKDs may transmit on their own schedule depending on charging status. First AP 115 may toggle first device 140 to transmit by varying pulse repetition rate of radar to charge the devices. Overtime, embodiments of the disclosure may recognize power dissipation per pulse. Based on the reflection of signals from first device 140, embodiment of the disclosure may perform Time-of-Flight (ToF) estimate after performing CIR to locate first device 140. As illustrated by FIG. 3, the delay determined between first signal 305 received at Rx antenna 315 and second signal 330 received at Rx antenna 315 may be used to approximate the range between AP 115 and first device 140.

Furthermore, based on the UWB radar, embodiments of the disclosure may capture multiple incoming waves at two or more Rx paths with different directional antennas to temporally map more devices at the same time. Once first AP 115 locates the BKD using the CIR of the reflection of the UWB signal in stage 230, method 200 may then end at stage 240.

### Backscattering AMP Device Signature Characterization

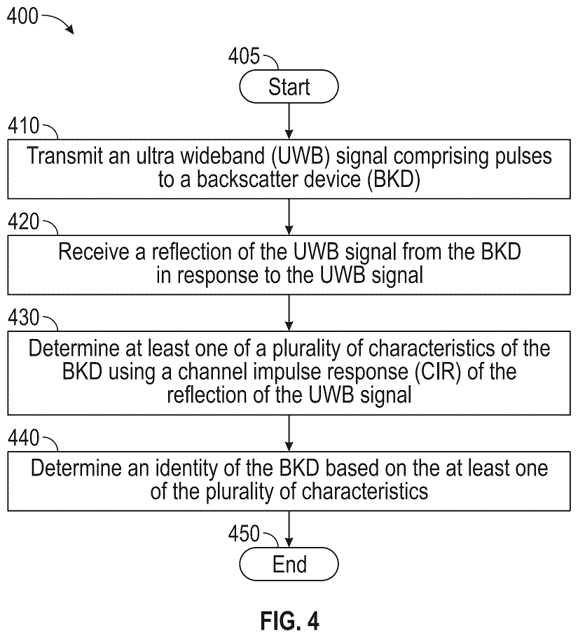

FIG. 4 is a flow chart setting forth the general stages involved in a method 400 consistent with embodiments of the disclosure for providing backscatter AMP device detection and characterization using UWB impulse radar. Method 400 may be implemented, for example, using computing device 500 embodied by first AP 115 as described in more detail above with respect to FIG. 1. Ways to implement the stages of method 400 will be described in greater detail below.

Method 400 may begin at starting block 405 and proceed to stage 410 where first AP 115 may transmit a UWB signal comprising pulses to a BKD (e.g. first device 140). For example, as described above, UWB radar may have a high repetition of electromagnetic impulses and may listen to its echo waves to characterize and locate objects in its vicinity.

From stage 410, where first AP 115 transmits the UWB signal comprising pulses to the BKD, method 400 may advance to stage 420 where first AP 115 may receive a reflection of the UWB signal from the BKD in response to the UWB signal. For example, as described above and shown in FIG. 3, first AP 115 may synthesize UWB pulses and transmit them as first signal 305 from its Tx antenna 310. First signal 305 may reflect off first device 140 (e.g., the BKD) and the reflection of first signal 305 off first device 140 may be received by Rx antenna 315 of first AP 115. Pulses may be transmitted as second signal 320 from Tx antenna 310, reflected off wall 325, and received by Rx antenna 315. Furthermore, pulses may be transmitted as third signal 330 from Tx antenna 310 and received directly by Rx antenna 315.

Once first AP 115 receive the reflection of the UWB signal from the BKD in response to the UWB signal in stage 420, method 400 may continue to stage 430 where first AP 115 may determine at least one of a plurality of characteristics of the BKD using a Channel Impulse Response (CIR) of the reflection of the UWB signal. For example, with high repetition of impulses from radar (even with lower energy) over time BKD may reflect back impulses with reflective properties encoded due to their mismatched loads. Impulses received and CIR of those pulses may reveal transmitted sidelobe levels due to reflections. On/off keying from the BKD devices that were encoded on radar impulses may reveal device characteristics. The plurality of characteristics may comprise, but are not limited to, encoded types, sidelobe levels, phase delay profile, response time (˜charging status), reflective properties identified from CIR, and transmission repetition rates. In addition, embodiments of the disclosure may keep track of CIR data to determine phase delay of the responses to identify devices.

After first AP 115 determines the at least one of a plurality of characteristics of the BKD using the CIR of the reflection of the UWB signal in stage 430, method 400 may proceed to stage 440 where first AP 115 may determine an identity of the BKD based on the at least one of the plurality of characteristics. For example, embodiments of the disclosure may provide a backscattering RF signature that may be unique to each BKD and used to identify it. Once first AP 115 determines the identity of the BKD based on the at least one of the plurality of characteristics in stage 440, method 400 may then end at stage 450.

### Spatial Mapping

UWB radar systems may achieve high spatial and range resolution due to their short pulses. Overtime, embodiments of the disclosure may spatially map BKDs (e.g., first plurality of devices 130) that are in network based, for example, on their characteristics. These characteristics may comprise, but are not limited to, encoded types, sidelobe levels, phase delay profile, response time (˜charging status), reflective properties identified from CIR, and transmission repetition rates. Embodiment of the disclosure may allow BKDs to encode above characteristics information in their frame data. Moreover, BKDs may be segregated based on above quantifying parameters and assign them different APs with UWB radios. The AP may then trigger exchanges when needed.

FIG. 5 is a block diagram of a computing device 500. As shown in FIG. 5, computing device 500 may include a processing unit 510 and a memory unit 515. Memory unit 515 may include a software module 520 and a database 525. While executing on processing unit 510, software module 520 may perform, for example, processes for providing backscatter AMP device detection and characterization using UWB impulse radar described with respect to FIG. 2 and FIG. 4. Computing device 500, for example, may provide an operating environment for controller 105, first AP 115, second AP 120, third AP 125, first device 140, second device 145, third device 150, first client device 155, second client device 160, and third client device 165. Controller 105, first AP 115, second AP 120, third AP 125, first device 140, second device 145, third device 150, first client device 155, second client device 160, and third client device 165 may operate in other environments and are not limited to computing device 500.

Computing device 500 may be implemented using an AP, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 500 may comprise any computer operating environment, such as hand-held devices, multiprocessor systems, microprocessor-based or programmable sender electronic devices, minicomputers, mainframe computers, and the like. Computing device 500 may also be practiced in distributed computing environments where tasks are performed by remote processing devices. The aforementioned systems and devices are examples, and computing device 500 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 500 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
transmitting, by a computing device, an Ultra Wideband (UWB) signal comprising pulses to a Backscatter Device (BKD);
receiving a reflection of the UWB signal from the BKD in response to the UWB signal; and
locating the BKD using a Channel Impulse Response (CIR) of the reflection of the UWB signal.

2. The method of claim 1, further comprising toggling the BKD to transmit by varying a pulse repetition rate of the UWB signal to charge the BKD.

3. The method of claim 2, further comprising determining a power dissipation of the BKD per pulse of the UWB signal.

4. The method of claim 1, further comprising determining a Time-of-Flight (ToF) of the reflection of the UWB signal.

5. The method of claim 4, wherein determining the ToF of the reflection of the UWB signal comprises determining a difference between a time when the UWB signal is received at a receive antenna and when the reflection of the UWB signal from the BKD is received at the receive antenna.

6. The method of claim 1, further comprising locating another BKD using a another receive antenna.

7. The method of claim 1, wherein the computing device comprises a Wi-Fi access point.

8. A method comprising:
transmitting, by a computing device, an Ultra Wideband (UWB) signal comprising pulses to a Backscatter Device (BKD);
receiving a reflection of the UWB signal from the BKD in response to the UWB signal;
determining at least one of a plurality of characteristics of the BKD using a Channel Impulse Response (CIR) of the reflection of the UWB signal; and
determining an identity of the BKD based on the at least one of the plurality of characteristics.

9. The method of claim 8, wherein the at least one of the plurality of characteristics comprises encoded types.

10. The method of claim 8, wherein the at least one of the plurality of characteristics comprises sidelobe levels.

11. The method of claim 8, wherein the at least one of the plurality of characteristics comprises a phase delay profile.

12. The method of claim 8, wherein the at least one of the plurality of characteristics comprises response time.

13. The method of claim 8, wherein the at least one of the plurality of characteristics comprises reflective properties identified from the CIR.

14. The method of claim 8, wherein the at least one of the plurality of characteristics comprises transmission repetition rates.

15. The method of claim 8, further comprising spatially mapping the BKD device based on the identity.

16. A system comprising:
a memory storage; and
a processing unit coupled to the memory storage, wherein the processing unit is operative to:
transmit an Ultra Wideband (UWB) signal comprising pulses to a Backscatter Device (BKD);
receive a reflection of the UWB signal from the BKD in response to the UWB signal; and
locate the BKD using a Channel Impulse Response (CIR) of the reflection of the UWB signal.

17. The system of claim 16, wherein the processing unit is further operative to toggle the BKD to transmit by varying a pulse repetition rate of the UWB signal to charge the BKD.

18. The system of claim 17, wherein the processing unit is further operative to determine a power dissipation of the BKD per pulse of the UWB signal.

19. The system of claim 16, wherein the processing unit is further operative to determine a Time-of-Flight (ToF) of the reflection of the UWB signal.

20. The system of claim 19, wherein the processing unit being operative to determine the ToF of the reflection of the UWB signal comprises the processing unit being operative to determine a difference between a time when the UWB signal is received at a receive antenna and when the reflection of the UWB signal from the BKD is received at the receive antenna.
